(19) United States
(12) Patent Application Publication
(10) Pub. No.: US 2015/0370092 A1
(43) Pub. Date: Dec. 24, 2015

(54) Variable-Power Lens

(71) Applicant: Adlens Ltd., Oxford (GB)

(72) Inventors: Jon Nisper, Oxford (GB); Robert Edwards Stevens, Oxford (GB)

(21) Appl. No.: 14/767,894

(22) PCT Filed: May 24, 2013
(86) PCT No.: PCT/EP2013/060814

§ 371 Date: Aug. 13, 2015

(30) Foreign Application Priority Data
Feb. 15, 2013 (GB) 1302719.8
Feb. 18, 2013 (GB) 1302792.5

(51) Int. Cl. G02C 7/08; G02C 9/00

(52) U.S. Cl. CPC G02C 7/081; G02C 9/00

(57) ABSTRACT

A variable-power lens includes first and second lens elements one behind the other along an optical axis of the lens. Each element has opposed planar and curved surfaces such that the thickness of each element in a direction parallel to the optical axis varies in a direction transverse to the optical axis. The elements are relatively moveable in the transverse direction, whereby the power of the lens may be varied. The elements are arranged such that the curved surface of the first element is adjacent the second element and the planar surface of the first element bears a diffractive pattern.

This invention relates to a variable-power lens of the type comprising first and second lens elements one behind the other along an optical axis of the lens.

This type of lens finds a multitude of uses. One area where it is particularly useful is in spectacles for people with presbyopia. The use of variable-power lenses allows the wearer of the spectacles to compensate by adjusting the lenses for their eyes' inability to accommodate the difference in focal length required to focus on distant and near objects.

The variable-power lens invented by Alvarez and described in his U.S. Pat. No. 3,305,294 works on the principle of having two lens element that slide over one another to adjust the lens power. It has many advantages for this type of scenario. In particular, it is relatively cost-effective to produce as the lens elements can be injection moulded. Furthermore, it is a simple arrangement, making it straightforward to assemble even in unspecialised manufacturing environment and it is easy for the user adjust.

Recently, significant interest has developed in adapting eyewear such as spectacles to incorporate head-up display functionality. Owing to their simplicity, the Alvarez lens would appear to be an excellent choice for this type of application where variable lenses are required. There are complications involved with achieving the integration of head-up display functionality with Alvarez lenses, however.

These complications arise from the need to apply a diffractive structure to a lens surface in order to cause the head-up display to appear in front of the user's eye or eyes. Each element of the Alvarez lens typically has a planar surface and a curved surface. The elements are arranged so that the planar surfaces are together in between the two elements. The curved surfaces are outermost. It is difficult to apply a diffraction grating film to the curved surface nearest the user's eye because it is liable to wrinkle during application. Furthermore, the linear spacing of a diffractive structure such as a diffraction grating film will be upset by application to a curved surface, leading to distortion of the image. The inner, planar surfaces are also unsuitable because the image projected on them in this location will be distorted by refraction in the lens element, which is disposed between the planar surface and the user's eye.

In accordance with a first aspect of the invention, there is provided a variable-power lens comprising first and second lens elements one behind the other along an optical axis of the lens, each element having opposed planar and curved surfaces such that the thickness of each element in a direction parallel to the optical axis varies in a direction transverse to the optical axis, the elements being relatively moveable in the transverse direction, whereby the power of the lens may be varied, wherein the elements are arranged such that the curved surface of the first element is adjacent the second element and the planar surface of the first element bears a diffractive pattern.

By arranging the elements in this way, the planar surface of the first lens element is caused to lie on the outside of the compound lens structure formed by the first and second elements. The planar surface is therefore available to bear a diffractive structure onto which an image can be projected to produce a head-up display. The refractive power of the compound lens varies with relative movement of the two elements in precisely the same way in this configuration as with the two planar surfaces together. The above-mentioned problems with wrinkling of the film and distortion of the image caused by refraction in one lens element or due to curvature of the diffractive structure are however overcome.

Since the elements are arranged such that the curved surface of the first element is adjacent the second element, the curved surface of the first element is facing the second element and the planar surface of the first element faces away from the second element. The planar surface of the first element is therefore exposed on the outside of the pair of lens elements and is available to receive a diffractive pattern on which an image can be projected.

In a preferred embodiment, the curved surface of one of the first and second elements is configured such that its thickness in the direction parallel to the optical axis is defined by the equation:

$${t}_{1} = A ( {xy}^{2} + \frac{1}{3} {x}^{3} ) + Dx + E$$

and the curved surface of the other of the first and second elements is configured such that its thickness in the direction parallel to the optical axis is defined by the equation:

$${t}_{2} = - A ( {xy}^{2} + \frac{1}{3} {x}^{3} ) - Dx + E$$

wherein x and y represent co-ordinates with respect to an x-axis extending in the transverse direction and a y-axis extending perpendicularly to the x-axis and the optical axis, A is a coefficient representing the rate of lens power variation with relative movement of the elements, D is a coefficient selected to control lens thickness, and E is a coefficient representing the lens thickness at the optical axis.

This preferred embodiment defines the usual Alvarez configuration. The coefficient D effectively defines a prism removed from each element to reduce, and preferably minimise, the overall lens thickness. By judicious selection of a value for A and provided the overall width of the lens in the x-direction is not too large, the value of D may be selected to be zero. The coefficient E could be zero, but in any event must have a value large enough to ensure structural rigidity of the lens elements. In one embodiment, the values of A, D and E may be 1, 0 and 0 respectively, provided that the overall width of the lens elements in the x-direction is small, for example less than or equal to 4 cm.

Typically, the second element is moveable and the first element is fixed. This prevents adjustment of the lens from disturbing an image projected on to the diffractive pattern. Because the diffractive pattern is borne by the first element, any movement of this relative to a projector would cause a disturbance.

The planar surface of the second element may face the first element.

In one embodiment, the diffractive pattern is provided by a diffraction grating film applied to the planar surface of the first element. This is very quick to manufacture and can be applied to existing production lines because an off-the-shelf diffraction grating film can be used.

In another embodiment, the diffractive pattern is formed in the planar surface of the first element. The diffractive pattern can be formed by moulding with the lens element itself or by embossing or grinding the lens element after it has been made. This embodiment allows for cheaper manufacture because the diffractive pattern can be formed with no additional manufacturing steps (when it is moulded). However, it would require existing tooling to be modified or potentially replaced.

In this embodiment, a coating having the same refractive index as the first element may be applied to the planar surface of the first element in the region of the diffractive pattern. This prevents light passing through the first element from being refracted by the diffractive pattern and therefore renders it invisible to the user and any observers.

In yet another embodiment, the diffractive pattern is provided by an exit pupil expander or bulk hologram applied to the planar surface of the first element. The exit pupil expander is particularly beneficial as it causes the image to occupy a larger area, meaning that the relative positions of the user's eye and the diffractive pattern are less critical.

In accordance with a second aspect of the invention, there is provided a pair of spectacles comprising a frame supporting at least one variable-power lens according to the first aspect of the invention.

Typically, the at least one variable-power lens is coupled to a mechanism configured to move the first and second elements of the at least one variable-power lens relative to each other.

The pair of spectacles preferably further comprises a projector configured to project an image on to the diffractive pattern of the at least one variable-power lens. The projector may be mounted on a temple arm of the spectacles and arranged to project the image towards the surface of the at least one variable-power lens closest to the user's eye. Naturally, this will normally be the planar surface of the first element, which bears the diffractive pattern.

Two projectors may be provided if both lenses are in accordance with the first aspect of the invention.

The pair of spectacles may further comprise a camera configured to receive an image from the diffractive pattern of the at least one variable-power lens. The image will usually be of the user's eye so that the camera can be used to monitor the position of the user's eye, for example for eye-tracking purposes.

An embodiment of the invention will now be described with reference to the accompanying drawings, in which:

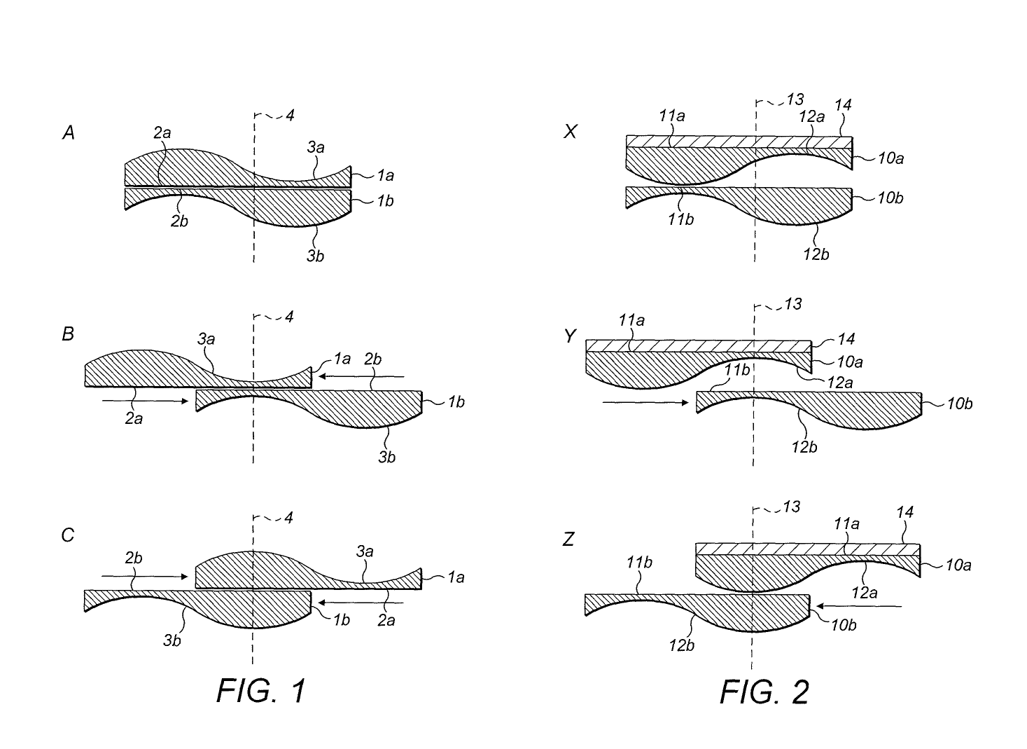

FIG. 1 shows schematically an Alvarez lens;

FIG. 2 shows schematically a variable-power lens according to the invention; and

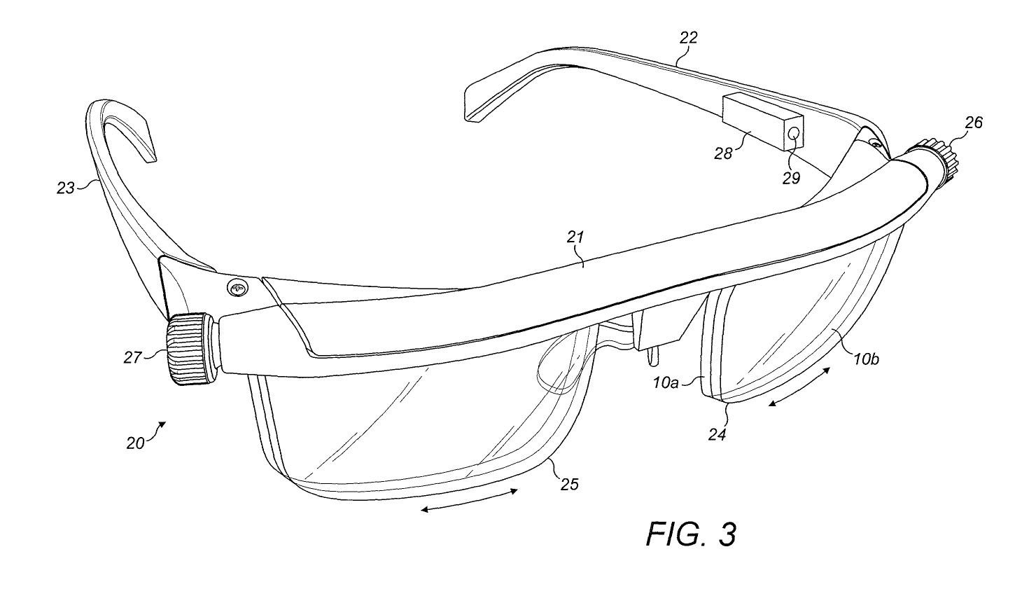

FIG. 3 shows a pair of spectacles comprising the lens of FIG. 1.

FIG. 1 shows a conventional Alvarez lens. This does not relate directly to the invention and it is only shown for purposes of comparison. The lens is shown in three different configurations, labelled as A, B and C. The lens has two lens elements 1a, 1b. Each lens element 1a, 1b has a planar surface 2a, 2b and a curved surface 3a, 3b.

In configuration A, the two lens elements 1a, 1b of the Alvarez lens are in a neutral position. They are not offset with respect to each other transversely to the optical axis 4. As such the curved surfaces 2a, 2b are aligned and the contours follow each other. In this neutral position, the radii of curvature of the two surfaces at any position offset transversely from the optical axis are the same. The result is that the combination of the two lens elements 1a, 1b in this configuration provides no optical power (assuming that the thickness of the lens is small compared to the radii of curvature of the two curved surfaces 2a, 2b so that any contribution to the overall focal length of the lens caused by the lens thickness along the optical axis 4 can be neglected).

In configuration B, the lens elements 1a, 1b are offset transversely from the optical axis 4 as shown by the arrows. The curved surfaces 2a, 2b are no longer aligned and the combination of the two lens elements 1a, 1b has a similar form to a biconcave lens. The Alvarez lens in this configuration is therefore a diverging lens.

Configuration C is the converse to configuration B; the lens elements 1a, 1b are offset transversely from the optical axis 4 in the opposite directions to those of configuration B. Again, this is shown by the arrows. The combination of the two lens elements 1a, 1b now has a similar form to a biconvex lens, and the Alvarez lens has therefore now become a converging lens.

FIG. 2 shows a variable-power lens according to the invention. In this lens, there are two lens elements 10a, 10b. The lens elements 10a, 10b may be made from any suitable lens material, such as crown or flint glass or an optical grade plastic, such as polycarbonate. The use of materials that can be moulded (e.g. polycarbonate or other suitable optical grade plastics) is preferable because it is difficult to grind the complex shape of the curved surfaces in glass.

Each lens element 10a, 10b has a planar surface 11a, 11b and a curved surface 12a, 12b. The curved surfaces 12a, 12b are configured such that their respective thicknesses in the direction parallel to the optical axis are defined by the following two equations:

$${t}_{1} = A ( {xy}^{2} + \frac{1}{3} {x}^{3} ) + Dx + E$$

$$and$$

$${t}_{2} = - A ( {xy}^{2} + \frac{1}{3} {x}^{3} ) - Dx + E$$

In these, equations t₁, and t₂ are the thicknesses of the curved surfaces 12a and 12b respectively; x and y represent co-ordinates with respect to an x-axis extending in a direction transverse to the optical axis and a y-axis extending perpendicularly to the x-axis and the optical axis; A is a coefficient representing the rate of lens power variation with relative movement of the lens elements 10a, 10b; D is a coefficient selected to control lens thickness; and E is a coefficient representing the lens thickness at the optical axis. The selection of suitable values for the coefficients A, D and E depends on various factors, including the overall dimension of the lens in the transverse direction. Those skilled in the art will be well aware how to choose suitable values for these coefficients without further instruction. U.S. Pat. No. 3,305,294, for example, provides an explanation of how to choose suitable values.

As can be seen, the lens element 10a is oriented differently to the lens element 1a of FIG. 1. Specifically, it is flipped on the optical axis 13 so that the curved surface 12a lies adjacent to the planar surface 11b. The lens of FIG. 2 is shown in three configurations labelled as X, Y and Z, which correspond to the configurations A, B and C of FIG. 1.

Thus, configuration X represents the neutral configuration. To the right-hand side of the optical axis 13, the lens element 10a effectively represents a planoconcave lens and lens element 10b effectively represents a planoconvex lens. The situation is reversed to the left-hand side of the optical axis 13 with the lens element 10a effectively representing a planoconvex lens and lens element 10b effectively representing a planoconcave lens. The radii of curvature of the two surfaces 12a, 12b at any position offset transversely from the optical axis 13 are the same. Thus, the two lens elements 10a, 10b complement each other and the resultant optical power is zero.

In configuration Y, the lens element 10b is shifted transversely to the optical axis 13 in the direction of the arrow. The lens element 10a is not moved. Thus, lens elements 10a and 10b both effectively represent planoconcave lenses. Thus, each lens element 10a, 10b acts as a diverging lens, and due to the proximity of the lens elements 10a, 10b along the optical axis 13, the optical powers of the two lens elements 10a, 10b are additive, with the result that the overall optical power is the sum of the optical powers of the two lens elements 10a, 10b.

In configuration Z, the lens element 10b is shifted transversely to the optical axis 13 in the direction of the arrow, which is the opposite direction to that of the arrow of configuration B. The lens element 10a is not moved. Thus, lens elements 10a and 10b both effectively represent planoconvex lenses. Thus, each lens element 10a, 10b acts as a converging lens, and due to the proximity of the lens elements 10a, 10b along the optical axis 13, the optical powers of the two lens elements 10a, 10b are additive, with the result that the overall optical power is the sum of the optical powers of the two lens elements 10a, 10b.

As can be seen, the arrangement of the two lens elements 10a, 10b in FIG. 2 is able to produce the same variation in optical power with relative movement of the two lens elements in a direction transverse to the optical axis 13 as the Alvarez lens arrangement shown in FIG. 1. However, because the lens element 10a is flipped on the optical axis 13, the planar surface 11a of the lens element 10a is exposed on the outside of the compound lens formed by lens elements 10a, 10b. This enables a diffractive pattern to be applied to the planar surface 11a. In the embodiment shown in FIG. 2, this is in the form of a diffraction grating film 14 applied across the planar surface 11a.

In other embodiments, the diffraction grating film may be applied only to a region of the planar surface 11a. The diffraction grating film may also be replaced by an exit pupil expander, which causes a diffracted image to occupy a larger area, meaning that the relative positions of the user's eye and the diffractive pattern are less critical. Alternatively, a diffractive pattern may be formed directly in the planar surface 11a by moulding the pattern into the surface when the lens element 10a is made. In this case, the diffractive pattern will normally be covered with a coating or film, which has the same refractive index as the material from which lens element 10a is made. This prevents the diffractive pattern from being seen by the user. Thus, there is a very low diffraction when looking straight through the lens element 10a, although the diffractive pattern may still provide high diffraction efficiency for high order diffraction.

The presence of the diffraction grating film 14 on planar surface 11a enables a head-up display functionality to be combined with the variable-power lens of FIG. 2. This will be explained with reference to FIG. 3, which shows a pair of spectacles 20. The spectacles 20 comprise a frame made up of a bridge section 21 and a pair of temple arms 22 and 23.

A pair of variable-power lenses 24 and 25 are housed in the bridge section 21. Each pair of lenses is of the type shown in FIG. 2, although the diffractive pattern may be omitted from lens 25. Indeed, lens 25 may be a conventional Alvarez lens of the type shown in FIG. 1.

In the case of lens 24, the lens element 10a will be closest to the user's eye whilst the lens element 10b will be furthest from the user's eye. Thus, lens element 10a is behind lens element 10b in FIG. 2. Lens element 10b is coupled to a thumbwheel 26, which enables the lens element 10b to be moved transversely to the optical axis whilst lens element 10a remains still. Lens element 10a is kept still because movement of the diffractive pattern 14 would disturb an image projected on to it. The thumbwheel 26 is coupled to a screw thread within the bridge section 21. Rotation of the thumbwheel 26 causes rotation of the screw thread, which drives the lens element 10b transversely across the optical axis 13 relative to lens element 10a. A similar mechanism is provided for lens 25, in which thumbwheel 27 causes the relative movement of the two lens elements of lens 25. In this case, either one or both of the lens elements of lens 25 may be moved.

A projector 28 is mounted on the temple arm 22. It comprises a miniature display, which projects an image through an aperture 29 towards the diffractive pattern 14 on lens element 10a on lens 24. The diffractive pattern is configured such that diffracted light will enter the user's eye and the image projected from projector 28 will be superimposed on the image visible to the user from refracted light passing through lens 24. The characteristics of the diffractive pattern 14 will need to be designed so that the light emitted by projector 28 is diffracted through the angle between the aperture 29 and the user's pupil. The skilled person would be well aware how to do this without explicit instruction as he will know that the angle through which light is diffracted by a diffraction grating is given by:

$${θ}_{m} = arc sin ( \frac{m λ}{d} - sin {θ}_{i} )$$

where θₘ is the angle of diffraction; m is the order of diffraction; λ is the wavelength of light; d is the spacing between slits (or other diffractive features) in the diffractive pattern; and θᵢ is the angle of incidence of the light from the projector 28. Given this equation, it is a straightforward matter to design a diffractive pattern by selecting a suitable value for d to cause light emitted by the projector 28 to be diffracted suitably so that the light will be diffracted into the user's pupil. In this embodiment, the diffraction grating is of course a reflective diffraction grating so that the light from the projector is reflected back towards the eye as well as diffracted through the correct angle as just discussed to cause the light to enter the user's pupil.

In other embodiments, the projector could be disposed alongside the diffractive pattern 14 rather than behind it as shown in FIG. 3. In this case, the system can be arranged to use a transmissive diffraction grating rather than reflective, the light from the projector being emitted at a suitable angle to enter the diffraction grating at its interface with the lens element 10a.

As can be seen from the above equation, the diffraction angle differs for different wavelengths. In some embodiment, the effects of this are minimised by using a projector that emits monochromatic light. The projector may be an organic light emitting diode (OLED) micro-display.

In other embodiments, the projector may be replaced or augmented by a camera for monitoring the position of the user's eye for example, for eye-tracking purposes.

1. A variable-power lens comprising:
first and second lens elements, one behind the other along an optical axis of the lens,
wherein each element has opposed planar and curved surfaces such that the thickness of each element in a direction parallel to the optical axis varies in a direction transverse to the optical axis, the elements being relatively moveable in the transverse direction, whereby the power of the lens may be varied, wherein the elements are arranged such that the curved surface of the first element is adjacent the second element and the planar surface of the first element bears a diffractive pattern.

2. The variable-power lens according to claim 1, wherein the curved surface of one of the first and second elements is configured such that its thickness in the direction parallel to the optical axis is defined by the equation:
$${t}_{1} = A ( {xy}^{2} + \frac{1}{3} {x}^{3} ) + Dx + E$$
and the curved surface of the other of the first and second elements is configured such that its thickness in the direction parallel to the optical axis is defined by the equation:
$${t}_{2} = - A ( {xy}^{2} + \frac{1}{3} {x}^{3} ) - Dx + E$$
wherein x and y represent co-ordinates with respect to an x-axis extending in the transverse direction and a y-axis extending perpendicularly to the x-axis and the optical axis, A is a coefficient representing the rate of lens power variation with relative movement of the elements, D is a coefficient selected to control lens thickness, and E is a coefficient representing the lens thickness at the optical axis.

3. The variable-power lens according to claim 1, wherein the second element is moveable and the first element is fixed.

4. The variable-power lens according to claim 1, wherein the planar surface of the second element faces the first element.

5. The variable-power lens according to claim 1, wherein the diffractive pattern is provided by a diffraction grating film applied to the planar surface of the first element.

6. The variable-power lens according to claim 1, wherein the diffractive pattern is formed in the planar surface of the first element.

7. The variable-power lens according to claim 6, further comprising a coating having the same refractive index as the first element applied to the planar surface of the first element in the region of the diffractive pattern.

8. The variable-power lens according to claim 1, wherein the diffractive pattern is provided by an exit pupil expander or bulk hologram applied to the planar surface of the first element.

9. A pair of spectacles comprising a frame supporting at least one variable-power lens, the variable power lens comprising:
first and second lens elements, one behind the other along an optical axis of the lens,
wherein each element has opposed planar and curved surfaces such that the thickness of each element in a direction parallel to the optical axis varies in a direction transverse to the optical axis, the elements being relatively moveable in the transverse direction, whereby the power of the lens may be varied, wherein the elements are arranged such that the curved surface of the first element is adjacent the second element and the planar surface of the first element bears a diffractive pattern.

10. The pair of spectacles according to claim 9, wherein the at least one variable-power lens is coupled to a mechanism configured to move the first and second elements of the at least one variable-power lens relative to each other.

11. The pair of spectacles according to claim 9, further comprising a projector configured to project an image on to the diffractive pattern of the at least one variable-power lens.

12. The pair of spectacles according to claim 9, further comprising a camera configured to receive an image from the diffractive pattern of the at least one variable-power lens.
